(19) United States
(12) Patent Application Publication
(10) Pub. No.: US 2011/0048471 A1
(43) Pub. Date: Mar. 3, 2011

(54) SUBSTRATE PROCESSING APPARATUS AND SUBSTRATE PROCESSING METHOD

(75) Inventor: Tsutomu KIKUCHI, Kamakura-shi (JP)

(73) Assignee: SHIBAURA MECHATRONICS CORPORATION, Yokohama-shi (JP)

(21) Appl. No.: 12/874,791

(22) Filed: Sep. 2, 2010

(30) Foreign Application Priority Data
Sep. 3, 2009 (JP) 2009-203402

(51) Int. Cl. B08B 3/00

(52) U.S. Cl. 134/34; 134/198

(57) ABSTRACT

A substrate processing apparatus includes at least one liquid droplets supplying nozzle configured to eject liquid droplets; and a liquid droplet atomizer configured to atomize the liquid droplets ejected from the nozzle to supply the atomized liquid droplets to a substrate.

### CROSS REFERENCE TO RELATED APPLICATION

This application is based upon and claims the benefit of priority from Japanese Patent Application No. 2009-203402 filed on Sep. 3, 2009, the entire contents of which are incorporated herein by reference.

### BACKGROUND OF THE INVENTION

1. Field of the Invention

The invention relates to a substrate processing apparatus and a substrate processing method, and particularly relates to a substrate processing apparatus for cleaning a substrate as a process object, for example a semiconductor wafer or the like, and a substrate processing method therefor.

2. Description of the Related Art

In the manufacturing processes of a substrate such as a semiconductor wafer or the like, a substrate processing apparatus processes the substrate by supplying a liquid (e.g. a chemical solution or the like) to the substrate. In this regard, Japanese Patent Application Publication No. 2007-103825 discloses a structure in which: a substrate is held on a turntable; a process nozzle is attached to an arm; and a process liquid is supplied to the substrate by moving the process nozzle together with the arm.

A conventional substrate processing apparatus as described above uses a spray cleaning technique for cleaning off contaminants on a substrate. In the spray cleaning technique, liquid droplets supplied to a substrate collides with the substrate and produce a pressure and a flow of a liquid, whereby they clean off contaminants on the substrate.

### SUMMARY OF INVENTION

Recent semiconductor substrates have fine patterns formed thereon. When contaminants are adhered to the pattern of the substrate, they will be removed by supplying liquid droplets thereto. However, the supplied liquid droplets may damage the pattern by the pressure thereof or the like.

Therefore, it is important to control energy of the liquid droplets to be supplied to the substrate for avoiding the damage of the pattern such as collapse. Specifically, the damage will be inhibited by control of the size, flying speed and the like of the liquid droplets by adjusting the shape of the nozzle and the like. A two-fluid nozzle may be used as a conventional spray nozzle in some cases. This two-fluid nozzle produces fine liquid droplets by: supplying a liquid and a gas to the nozzle; and mixing the liquid and the gas in the inside of the nozzle.

However, as a pattern on a substrate becomes finer, such a finer pattern is still likely to be damaged, e.g., collapsed even if the conventional two-fluid nozzle controls energy of liquid droplets supplied to the substrate. Specifically, it is difficult to simultaneously achieve highly efficient removal of contaminants and the reduction in damage of the pattern when the substrate is cleaned by collision of the liquid droplets with the substrate by use of the conventional two-fluid nozzle.

An object of the present invention is to provide a substrate processing apparatus and a substrate processing method which are capable of removing contaminants adhering to a substrate while preventing damage of a finer pattern on the substrate, such as collapse of the pattern.

A first aspect of the present invention is a substrate processing apparatus configured to perform a cleaning process on a substrate by supplying liquid droplets to the substrate. The substrate processing apparatus comprises: at least one liquid droplets supplying nozzle configured to eject liquid droplets; and a liquid droplet atomizer configured to atomize the liquid droplets ejected from the liquid droplets supplying nozzle to supply the atomized liquid droplets to the substrate.

The at least one liquid droplets supplying nozzle may include multiple nozzles. It is desirable that the liquid droplet atomizer arranges the plurality of nozzles in away that flows of the liquid droplets ejected respectively from the plurality of nozzles intersect with one another, and the liquid droplet atomizer thus forms a liquid-droplets intersecting area in which the liquid droplets ejected from the plurality of nozzles collide against one another.

It is desirable that the liquid droplet atomizer includes at least one gas supplying nozzle configured to supply a gas to the liquid droplets which are ejected from the liquid droplets supplying nozzle.

It is desirable that a nozzle axis of the gas supplying nozzle should intersect a nozzle axis of the liquid droplets supplying nozzle in order to cause a turbulent flow of the liquid droplets in an area between an ejection port of the liquid droplets supplying nozzle and the substrate.

The at least one liquid droplets supplying nozzle may include the multiple nozzles. In this case, the liquid droplet atomizer may be a holding member configured to hold the multiple nozzles integrally.

The liquid droplet atomizer may include a holding member configured to hold the liquid droplets supplying nozzle and the gas supplying nozzle integrally.

A second aspect of the present invention is a substrate processing method for performing a cleaning process on a substrate by supplying liquid droplets to the substrate. The method comprises the steps of: ejecting liquid droplets; and atomizing the liquid droplets more finely, and supplying the atomized liquid droplets to the substrate.

The present invention can provide the substrate processing apparatus and the substrate processing method which allow removal of contaminants adhering to the substrate while preventing the damaging of a finer pattern, such as collapse of the pattern.

### BRIEF DESCRIPTION OF THE DRAWINGS

FIG. 1 is a diagram showing a substrate processing apparatus according to a first embodiment of the present invention.

FIG. 2 is a diagram showing an example of a configuration of a process unit in the substrate processing apparatus shown in FIG. 1.

FIG. 3 is a diagram showing an example of an internal configuration of a spray nozzle in detail.

FIG. 4 is a diagram showing a process unit in a substrate processing apparatus according to a second embodiment of the present invention.

FIG. 5 is a diagram of a configuration of a spray nozzle in the process unit shown in FIG. 4.

FIG. 6 is a diagram showing a comparison between a distribution of sizes of liquid droplets which are produced by the substrate processing apparatus according to each of the embodiments of the present invention and are then supplied to a substrate and a distribution of sizes of liquid droplets which are produced by a conventional two-fluid nozzle and are then supplied to a substrate.

FIG. 7 is a diagram showing a comparison between a rate of removing particles from a top of a substrate, which is obtained by use of liquid droplets supplied to the substrate by the substrate processing apparatus according to each of the embodiments of the present invention, and a rate of removing particles from a top surface of a substrate, which is obtained by use of liquid droplets supplied to the substrate by the conventional two-fluid nozzle.

FIG. 8 is a diagram showing a rate of occurrence of liquid droplets with respect to energy.

FIGS. 9A and 9B are diagrams showing an example of collision between, and an example of division of liquid droplets ejected from nozzles in each of the substrate processing apparatuses according to the respective embodiments of the present invention. FIG. 9C is a diagram showing a comparative example of collision between liquid droplets.

### DESCRIPTION OF EMBODIMENTS

Descriptions will be provided for embodiments of the present invention with reference to the drawings.

### First Embodiment

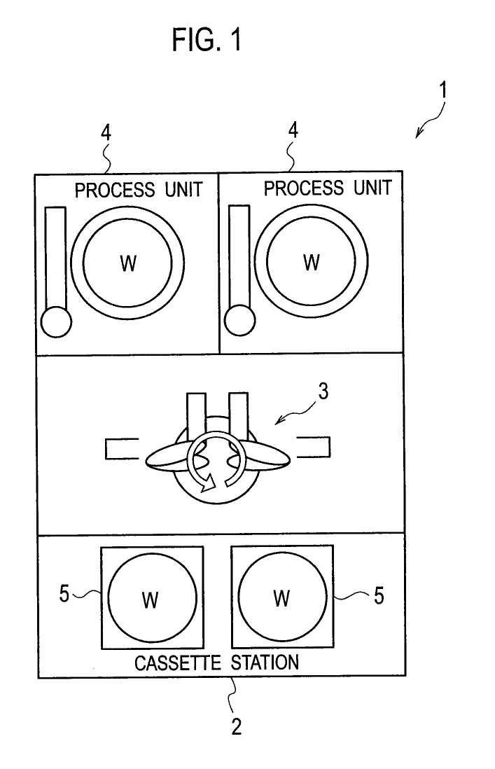

FIG. 1 shows a substrate processing apparatus according to a first embodiment of the present invention.

The substrate processing apparatus 1 shown in FIG. 1 includes a cassette station 2, a robot 3 and multiple process units 4, 4.

The substrate processing apparatus 1 is an apparatus performing processes individually for each substrate, and the apparatus is sometimes called as a single substrate (wafer) processing apparatus. The cassette station 2 includes multiple cassettes 5, 5. Each cassette 5 contains multiple substrates W. The substrates are semiconductor wafer substrates, for instance.

The robot 3 is placed between the cassette station 2 and the multiple process units 4, 4. The robot 3 transfers the substrates W contained in each cassette 5 to the corresponding process unit 4. The robot 3 returns the substrates W after being processed by the process unit 4 to the other cassette 5. Each process unit 4, for instance, cleans a top surface of the substrate W by supplying liquid droplets to the top surface while holding and rotating the substrate W.

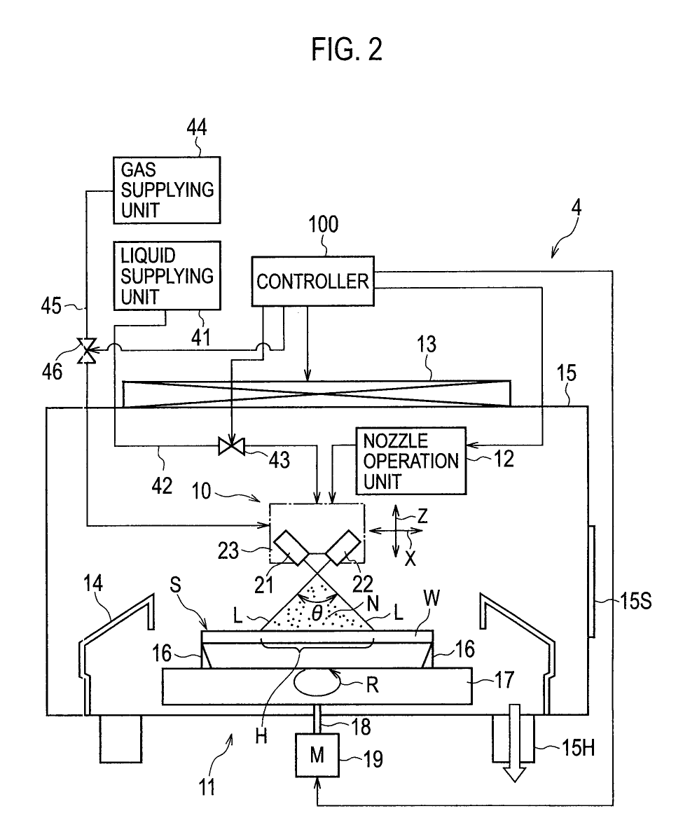

FIG. 2 shows an example of a configuration of the process units 4 in the substrate processing apparatus 1 shown in FIG. 1.

The process unit 4 shown in FIG. 2 is a spin cleaner configured to clean the substrates W individually, which are process objects. The process unit 4 includes a spray nozzle (liquid droplets supplying nozzle) 10, a substrate holder 11, a nozzle operation unit 12, a filtered fan 13 for downflow, a cup 14, a process chamber 15, and a controller 100.

The substrate holder 11 shown in FIG. 2 includes a disc-shaped base member 17, a rotary shaft 18, and a motor 19. The base member 17 is a turntable. A substrate W is detachably fixed (chucked) to the top of the base member 17 so as to be raised above the base member 17 by use of multiple chuck pins 16. The multiple chuck pins 16 are placed in a circumferential direction of the base member 17. For instance, three pins are placed at 120 degree intervals.

The spray nozzle 10, the cup 14, the base member 17, and the rotary shaft 18 of the motor 19 are accommodated inside the process chamber 15 shown in FIG. 2. The base member 17 is fixed to a tip portion of the rotary shaft 18. The base member 17 is capable of continuously rotating in a direction indicated by a reference sign R when the base motor 19 is operated in response to a command from the controller 100.

The cup 14 shown in FIG. 2 is installed around the substrate holder 11. The cup 14 is designed to be capable of recovering the liquid droplets and the gas, which are supplied to the surface of the substrate W, by discharging the liquid droplets and the gas through a discharge unit 15H to the outside of the process unit 4. A discharge pump (not illustrated) is connected to the tip of the discharge unit 15H. The process unit 4 includes a shutter 15S through which the substrate is put into and out of the process unit 4.

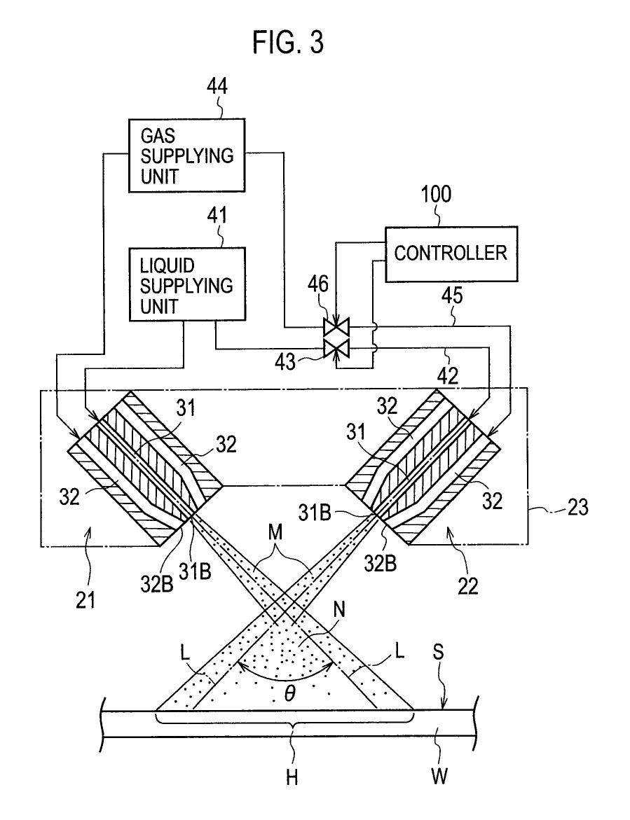

Descriptions will be provided for a configuration of the spray nozzle 10 with reference to FIGS. 2 and 3. FIG. 3 is a diagram showing an example of an internal configuration of the spray nozzle 10 in detail.

As shown in FIG. 2, the spray nozzle 10 is a two-fluid nozzle, for instance. The spray nozzle 10 is placed above the substrate W. When the nozzle operation unit 12 is operated in response to a command from the controller 100, the spray nozzle 10 is capable of moving in the Z direction (in the vertical direction) and in the X direction (in the radial direction of the substrate W), and is capable of ejecting fine liquid droplets, which are even in size, to a surface S of the substrate W.

As shown in FIGS. 2 and 3, the spray nozzle 10 includes a first nozzle 21 and a second nozzle 22. Each of the first nozzle 21 and the second nozzle 22 is a two-fluid nozzle. It is desirable that the first nozzle 21 and the second nozzle 22 is integrally held by a holding member 23. When the first nozzle 21 and the second nozzle 22 are held integrally, the first nozzle 21 and the second nozzle 22 are not displaced from each other in the course of moving, and are accordingly capable of moving integrally. This makes it possible to simplify the configuration of the spray nozzle 10.

As shown in FIG. 3, each of the first nozzle 21 and the second nozzle 22 has a two-fluid nozzle structure, and includes a first passage 31 and a second passage 32. As the wiring pattern on the wafer becomes finer, particles (contaminants) adhering to the pattern become smaller and smaller in diameter. With this taken into consideration, the two-fluid nozzle with a high cleaning power is used for efficiently cleaning off particles.

As shown in FIG. 3, the first passage 31 and the second passage 32 of the first nozzle 21 are formed coaxially with a nozzle axis L of the first nozzle 21. Similarly, the first passage 31 and the second passage 32 of the second nozzle 22 are formed coaxially with a nozzle axis L of the second nozzle 22. Each first passage 31 has a round cross section. Each second passage 32 is formed around the corresponding first passage 31.

In FIG. 3, at the time when a liquid is ejected from each ejection port 31B through the corresponding first passage 31, a gas is ejected from each ejection port 32B through the corresponding second passage 32. Thereby, the liquid is atomized into a mist, and thus fine-sized liquid droplets M can be produced.

As shown in FIG. 3, the first passage 31 of the first nozzle 21 and the first passage 31 of the second nozzle 22 are connected to a liquid supplying unit 41 through a pipe 42 and a valve 43. Similarly, the second passage 32 of the first nozzle 21 and the second passage 32 of the second nozzle 22 are connected to a gas supplying unit 44 through a pipe 45 and a valve 46. Accordingly, the liquid is supplied from the liquid supplying unit 41 to the first passage 31 of the first nozzle 21 and the first passage 31 of the second nozzle 22 once the valve 43 is opened in response to a command from the controller 100. In addition, the gas is supplied from the gas supplying unit 44 to the second passage 32 of the first nozzle 21 and the second passage 32 of the second nozzle 22 once the valve 46 is opened in response to a command from the controller 100. Accordingly, finely-atomized liquid droplets M are produced by both of the first nozzle 21 and the second nozzle 22 simultaneously. Meanwhile, illustration of the valves 43 and 46 provided for the first nozzle 21 is omitted in FIG. 3.

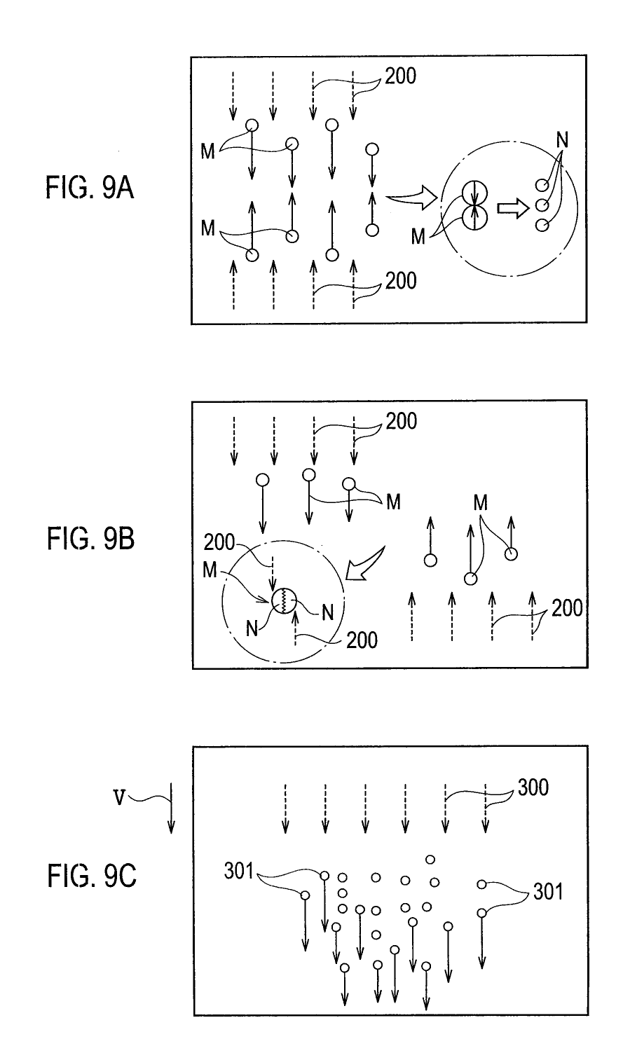

FIG. 9A schematically shows an example of collision between liquid droplets ejected from the nozzle 21 and ejected from the nozzle 22 in each of the substrate processing apparatuses according to the respective embodiments of the present invention. FIG. 9B schematically shows an example of division of liquid droplets ejected from the nozzles 21, 22. FIG. 9C schematically shows a comparative example of simple collision of liquid droplets.

As shown in FIG. 9A, when air flows 200 indicated by broken lines flow in opposite directions, a turbulent flow occurs due to these air flows 200, and orientations of liquid droplets M are accordingly disturbed. This disorientation makes the liquid droplets M collide against one another. Accordingly, liquid droplets N which are smaller in size than the liquid droplets M can be produced. In addition, as shown in FIG. 9B, when a turbulent flow occurs due to the air flows 200, the liquid droplets M are divided by being subjected to a force in a direction which is opposite to the original direction of the liquid droplet M. Thus, the liquid droplets N which are smaller in size than liquid droplets M can be produced.

In contrast, in the comparative example shown in FIG. 9C, it is difficult for liquid droplets 301 to collide against one another, and to be divided into smaller pieces because an air flow 300 flows only in a direction indicated by reference sign V with respect to the liquid droplets 301.

The liquid supplying unit 41 supplies pure water as an instance of the liquid. The gas supplying unit 44 supplies a nitrogen gas as an instance of the gas.

As shown in FIGS. 2 and 3, the nozzle axis L of the first nozzle 21 and the nozzle axis L of the second nozzle 22 intersect at a crossing angle θ. In other words, the first nozzle 21 and the second nozzle 22 are integrally and obliquely held by the holding member 23 in a way that the ejection port 31B of the first nozzle 21 and the ejection port 31B of the second nozzle 22 come close to each other, as shown in FIG. 3.

As described above, the nozzle axis L of the first nozzle 21 and the nozzle axis L of the second nozzle 22 intersect at the crossing angle θ. For this reason, the liquid droplets M finely-atomized by the ejection from the first nozzle 21 and the liquid droplets M finely-atomized by the ejection from the second nozzle 22 are more finely atomized through their collision and division. Thereby, the more finely-atomized liquid droplets N can be produced. The liquid droplets N produced through the finer atomization in this manner are controlled so as to have the finer size. In addition, the liquid droplets N reach the substrate W.

A liquid droplet atomizer is the holding member 23. The holding member 23 holds the first nozzle 21 and the second nozzle 22 in a way that the flows of the liquid droplets M ejected from the first nozzle 21 and ejected from the second nozzle 22 intersect. This measure is taken for more finely atomizing the liquid droplets M ejected from both the first nozzle 21 and the second nozzle 22 in the spray nozzle 10 to obtain the liquid droplets N and thus supplying the liquid droplets N to the substrate W. This holding member 23 forms a liquid-droplets intersecting area H in which the liquid droplets M ejected from the first nozzle 21 and ejected from the second nozzle 22 intersect. In the liquid-droplets intersecting area H, it is possible to produce the liquid droplets N which are smaller in size than the liquid droplets M through the collision and division of the liquid droplets M.

It is desirable that this crossing angle θ is 90 degrees or larger and smaller than 180 degrees. Even in a case where, however, the crossing angle θ is smaller than 90 degrees, it is possible to sufficiently prevent the damage of the fine pattern on the substrate W, such as collapse of the pattern. It is more preferable that the crossing angle θ is set in a range of 120 degrees to 160 degrees. This setting allows producing the more finely-atomized liquid droplets N which are capable of removing contaminants from the substrate W without the damage of the fine pattern on the substrate W, such as collapse of the pattern.

Next, with reference to FIGS. 2 and 3, descriptions will be provided for a cleaning process for cleaning, for instance, the surface S of the substrate W by use of the process units 4 included in the foregoing substrate processing apparatus 1.

The substrate W shown in FIG. 2, which is the process object, is detachably fixed to the top of the base member 17 so as to be raised above the base member 17 by use of the multiple chuck pins 16. When the motor 19 is operated in response to a command from the controller 100, the substrate W together with the base member 17 is rotated in the direction indicated by reference sign R.

When the valve 43 is opened in response to a command from the controller 100 shown in FIG. 2, the liquid is supplied from the liquid supplying unit 41 to the first passage 31 of the first nozzle 21 and the first passage 31 of the second nozzle 22. In addition, when the valve 46 is opened in response to a command from the controller 100, the gas is supplied from the gas supplying unit 44 to the second passage 32 of the first nozzle 21 and the second passage 32 of the second nozzle 22.

As shown in FIG. 3, at the time when the liquid is ejected from the ejection ports 31B through the corresponding first passages 31, the gas is ejected from the ejection ports 32B through the corresponding second passages 32. Thereby, the liquid is atomized into a mist, and thus the fine-sized liquid droplets M can be produced. In other words, the liquid is atomized into a mist by the gas. Accordingly, the finely-atomized liquid droplets M (which are atomized into a mist) are produced by both of the first nozzle 21 and the second nozzle 22 simultaneously.

In addition, the liquid-droplets intersecting area H is formed by causing collision and division of the liquid droplets M finely-atomized through the ejection from the first nozzle 21 and the liquid droplets M finely-atomized through the ejection from the second nozzle 22. In the liquid-droplets intersecting area H, the liquid droplets M can be atomized more finely through the collision and division of the liquid droplets M. The liquid droplets N produced through the finer atomization in this manner are controlled so as to have the finer size. In addition, such liquid droplets N reach the substrate W.

As described above, in the first atomization step, the finely-atomized liquid droplets M are produced by ejecting the liquid such as pure water from the first nozzle 21 and the second nozzle 22. Then, in the second atomization step, the more finely-atomized liquid droplets N are formed from the finely-atomized liquid droplets M through the collision and division of the liquid droplets M in the liquid-droplets intersecting area H. These liquid droplets N are thereafter supplied to the surface of the substrate W. For this reason, the liquid droplets N controlled so as to have the fine size can remove contaminants from the substrate W without the damaging of the fine pattern on the substrate W, such as collapse of the pattern.

### Second Embodiment

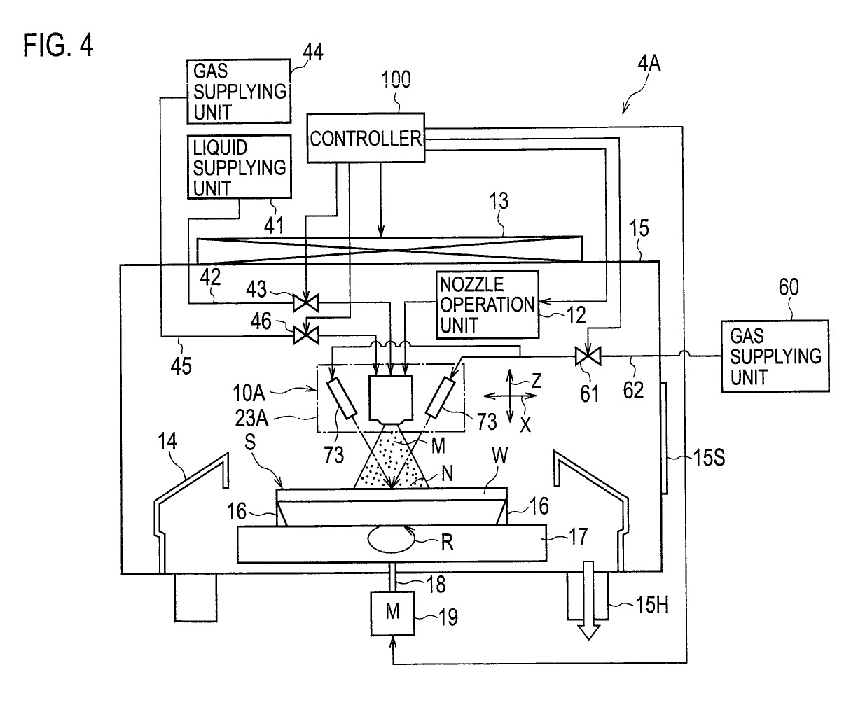

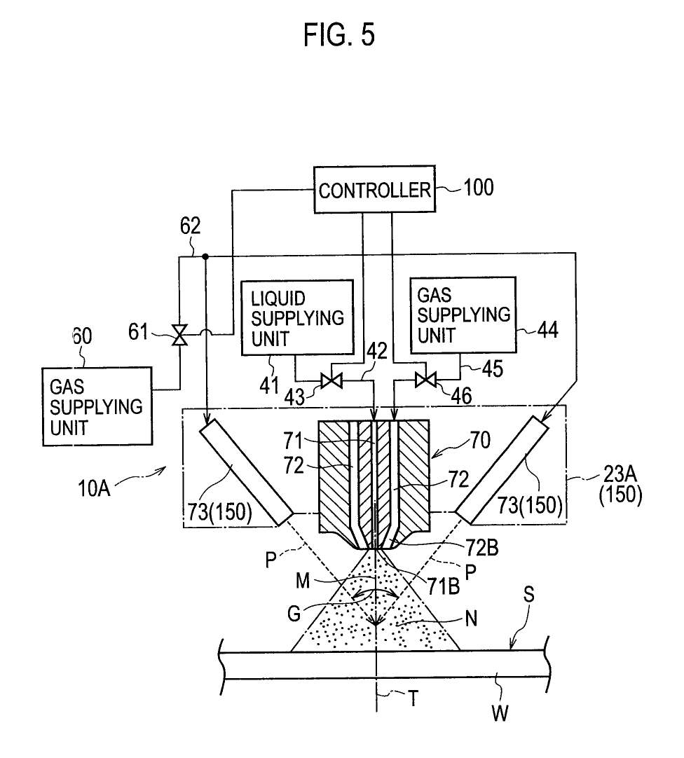

Next, descriptions will be provided for a substrate processing apparatus according to a second embodiment of the present invention with reference to FIGS. 4 and 5.

FIG. 4 shows a process unit 4A included in the substrate processing apparatus according to the second embodiment of the present invention. FIG. 5 shows a configuration of a spray nozzle (liquid droplets supplying nozzle) 10A included in the process unit 4A shown in FIG. 4.

Of the process unit 4A shown in FIG. 4, components substantially identical to the components of the process unit 4 shown in FIG. 2 are denoted by the same reference signs. Descriptions for such components, which are made in the first embodiment, are incorporated herein by reference. The only difference between the components of the process unit 4A shown in FIG. 4 and the components of the process unit 4 shown in FIG. 2 is a configuration of a spray nozzle 10A.

The spray nozzle 10A shown in FIGS. 4 and 5 includes a single two-fluid nozzle 70 and two gas supplying nozzles 73. These are integrally held by a holding member 23A, and are accordingly capable of moving integrally. This makes it possible to simplify the structure of the spray nozzle 10A.

As shown in FIG. 5, the two-fluid nozzle 70 has a two-fluid nozzle structure in which a first passage 71 and a second passage 72 are provided. The first passage 71 and the second passage 72 are formed coaxially with a nozzle axis T. The first passage 71 has a round cross section, and the second passage 72 is formed around the first passage 71.

As shown in FIG. 5, the first passage 71 of the two-fluid nozzle 70 is connected to the liquid supplying unit 41 through the pipe 42 and the valve 43. Similarly, the second passage 72 of the two-fluid nozzle 70 is connected to the gas supplying unit 44 through the pipe 45 and the valve 46. Accordingly, the liquid is supplied from the liquid supplying unit 41 to the first passage 71 of the two-fluid nozzle 70 when the valve 43 is opened in response to a command from the controller 100. In addition, the gas is supplied from the gas supplying unit 44 to the second passage 72 of the two-fluid nozzle 70 when the valve 46 is opened in response to a command from the controller 100.

At the time when the liquid is ejected from an ejection port 71B through the first passage 71, the gas is ejected from an ejection port 72B through the second passage 72. Thereby, the liquid is atomized into a mist, and thus the fine-sized liquid droplets M can be produced. The liquid supplying unit 41 supplies pure water as an instance of the liquid. The gas supplying unit 44 supplies a nitrogen gas as an instance of the gas.

Meanwhile, as shown in FIG. 5, the two gas supplying nozzles 73 are connected to the gas supplying unit 60 through a valve 61 and a pipe 62. The holding member 23A obliquely holds the two gas supplying nozzles 73 in a way that their ejection ports come close to each other. Nozzle axes P of the respective two gas supplying nozzles 73 intersect at a crossing angle G and also intersect nozzle axis T of the two-fluid nozzle 70 in an area between the ejection port of the two-fluid nozzle 70 and the substrate W. An angle of the nozzle axis P of each of the two gas supplying nozzles 73 to the nozzle axis T of the nozzle 70 is represented by G/2. When the two gas supplying nozzles 73 eject the gas, such as a nitrogen gas, toward the liquid droplets M, a turbulent flow area is produced. The liquid droplets M are collided with each other or divided in the turbulent flow area and are more finely atomized to form liquid droplets N as described later. The liquid droplets N reach the substrate W. The two gas supplying nozzles 73 and the holding member 23A configured to hold these two gas supplying nozzles 73 constitute a liquid droplet atomizer 150.

Next, with reference to FIGS. 4 and 5, descriptions will be provided for a cleaning process for cleaning, for instance, the surface S of the substrate W by use of the process unit 4A included in the substrate processing apparatus.

The substrate W shown in FIG. 4, which is the process object, is detachably fixed to the top of the base member 17 so as to be raised above the base member 17 by use of multiple chuck pins 16. Once the motor 19 is operated in response to a command from the controller 100, the substrate W together with the base member 17 is rotated in the direction indicated by reference sign R.

When the valve 43 is opened in response to a command from the controller 100 shown in FIG. 4, the liquid is supplied from the liquid supplying unit 41 to the first passage 71 of the nozzle 70. In addition, when the valve 46 is opened in response to a command from the controller 100, the gas is supplied from the gas supplying unit 44 to the second passage 72 of the nozzle 70. Thereby, the finely-atomized liquid droplets M are produced by the nozzle 70. As shown in FIG. 5, at the time when the liquid is ejected from the ejection port 71B through the first passage 71, the gas is ejected from the ejection port 72B through the second passage 72. Accordingly, the liquid is atomized into a mist, and thus the fine-sized liquid droplets M can be produced.

As shown in FIG. 9A, when air flows 200 indicated by broken lines flaw in the opposite directions, a turbulent flow occurs due to these air flows 200, and orientations of the liquid droplets M are accordingly disturbed. This disorientation makes the liquid droplets M collide against one another. Accordingly, liquid droplets N which are smaller in size than the liquid droplets M can be produced. In addition, as shown in FIG. 9B, when a turbulent flow occurs due to the air flows 200, the liquid droplets M are divided by being subjected to a force in a direction which is opposite to the original direction of the liquid droplet M. Thus, the liquid droplets N which are smaller in size than the liquid droplets M can be produced.

In contrast, in the case of the comparative example shown in FIG. 9C, it is difficult for the liquid droplets 301 to collide against one another, and to be divided into smaller pieces because the air flow 300 flows only in the direction indicated by reference sign V with respect to the liquid droplets 301.

As described above, the gas is ejected from the ejection ports of the respective two gas supplying nozzles 73 to the liquid droplets M ejected from the nozzle 70. Thereby, the liquid droplets M are more finely atomized by a turbulent flow which is caused by the ejected gas. The turbulent flow causes the liquid droplets M to collide against one another and to be divided into smaller pieces so that the liquid droplets M are more finely atomized. Accordingly, it is possible to produce the more finely-atomized liquid droplets N. The liquid droplets N thus produced through the finer atomization are controlled in order that the size of the liquid droplets N can become finer. In addition, such liquid droplets N are designed to be capable of reaching the substrate W.

In the first atomization step, the finely-atomized liquid droplets M are produced by ejecting the liquid such as pure water from the nozzle 70. Then, in the second atomization step, the more finely-atomized liquid droplets N are formed from the finely-atomized liquid droplets M through the collision and division of the liquid droplets M in the turbulent flow area. These liquid droplets N are thereafter supplied to the surface S of the substrate W. For this reason, the liquid droplets N controlled so as to have the fine size can remove contaminants from the substrate W without the damaging of the fine pattern on the substrate W, such as collapse of the pattern.

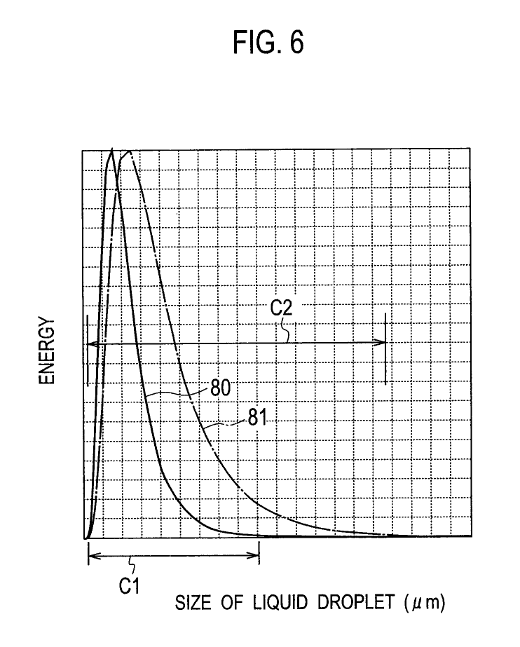

FIG. 6 shows a comparison between a distribution 80 of sizes of liquid droplets which are supplied to a substrate after produced by the substrate processing apparatus according to each of the embodiments of the present invention and a distribution 81 of sizes of liquid droplets which are supplied to a substrate after produced by the conventional two-fluid nozzle.

As indicated in the distribution 80 shown in FIG. 6, the distribution width C1 of sizes of liquid droplets is narrower than the distribution width C2 of sizes of liquid droplets for the distribution 81 according to the conventional example. In other words, since the distribution width C1 for the distribution 80 is concentrated on a narrower droplet size width than the distribution width C2 for the distribution 81 according to the conventional example, it is clear that the present invention makes the sizes of liquid droplets more finely.

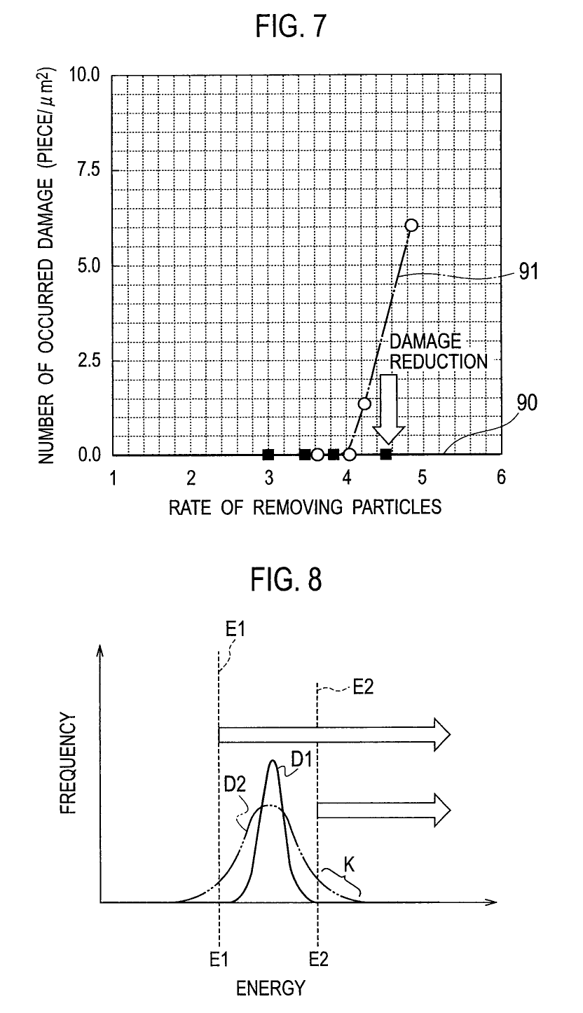

FIG. 7 shows a comparison between a rate 90 of removing particles (contaminants) from a substrate, which is obtained by use of liquid droplets supplied to the substrate by the substrate processing apparatus according to each of the embodiments of the present invention, and a rate 91 of removing particles (contaminants) from a substrate, which is obtained by use of liquid droplets supplied to the substrate by the conventional two-fluid nozzle. In FIG. 7, the horizontal axis represents the rate of removing particles, while the vertical axis represents the number of damages which occurred on a pattern on the substrate. The rate 90 of removing particles concerning the present invention is plotted by squares, and the rate 91 of removing particles concerning the conventional example is plotted by circles.

As shown in FIG. 7, no matter what the rate of removing particles is, the embodiments of the present invention can reduce the rate of damage occurrence on the pattern of the substrate to zero. In contrast, in the case where the conventional two-liquid nozzle is used, it is clear that the rate of damage occurrence on the pattern of the substrate sharply increases as the rate of removing particles increases. To put it specifically, the embodiments of the present invention cause no damage on the pattern of the substrate even though particles are removed from the substrate, and accordingly can make it less likely to damage the pattern while keeping the rate of removing particles to a high level. In contrast, in the case of the conventional example, the more the particles are removed from the substrate, the more likely the pattern of the substrate is damaged.

FIG. 8 shows a rate of occurrence of liquid droplets with respect to energy. FIG. 8 shows an energy level E1 at which particles adhere to a substrate, and an energy level E2 at which a pattern on a substrate is damaged, e.g., the pattern is collapsed.

A curve D1 representing energy of liquid droplets produced by the substrate processing apparatus according to the embodiments of the present invention and a curve D2 representing energy of liquid droplets according to the conventional example exist between these energy levels E1, E2 shown in FIG. 8. The curve D1 representing energy of liquid droplets completely falls within a range between the energy levels E1, E2. On the other hand, the curve D2 representing energy of liquid droplets according to the conventional example includes a part K which overlaps the energy level E2. The existence of the overlapping part K means that a pattern on a substrate is to be damaged when liquid droplets according to the conventional example are supplied to the pattern. It is clear from FIG. 8, too, that the embodiments of the present invention cause no damage on the pattern of the substrate even though particles are removed from the substrate and the embodiments accordingly can make it less likely to damage the pattern while keeping the rate of removing particles to a high level.

The embodiments of the present invention can produce liquid droplets which are even in size, and thus can supply these liquid droplets to the substrate. For this reason, the embodiments thereof can enhance the controllability of the pressure of the liquid droplets to be applied to the substrate, and the distribution of flow speed of the liquid droplets. In addition, the embodiments thereof can remove contaminants from the substrate while preventing the damaging of the pattern on the substrate, such as collapse of the pattern. Furthermore, the embodiments thereof can control the energy of the liquid droplets to be applied to the substrate in order that the energy can be small. Moreover, the embodiments thereof can minutely (finely) control the energy applied to the substrate, and accordingly can remove contaminants which remains on the pattern without the damaging of the pattern on the substrate. Besides, the embodiments thereof can easily control the size of the liquid droplets, and accordingly can control cleaning conditions appropriately. Further, the embodiments thereof can independently control the size of the liquid droplets and the speed of the liquid droplets with their respective control factors, and accordingly can control the condition of the liquid droplets to be supplied to the substrate.

The present invention is not limited to the above-described embodiments. For instance, the first nozzle 21 and the second nozzle 22 shown in FIG. 3 are integrally held by the holding member 23. This allows simplifying the layout of components needed to be placed above the substrate, such as the nozzles and pipes, inside the substrate processing apparatus. However, the present invention is not limited to this. The first nozzle and the second nozzle may be formed as separate bodies without using the holding member. The nozzle is not limited to the two-fluid nozzle. The nozzle may be a nozzle of a different type, for instance, a nozzle of a spray type from which liquid droplets are ejected.

In addition, the nozzle 70 and the gas supplying nozzle 73 which are shown in FIG. 5 are integrally held by the holding member 23A. This allows simplifying the layout of components needed to be placed above the substrate, such as the nozzles and pipes, inside the substrate processing apparatus.

The number of nozzles held by the holding member is not limited to two, and may be three or more. Increase in the number of nozzles makes it possible to produce a larger amount of finely-atomized liquid droplets N, and accordingly to supply the larger amount of finely-atomized liquid droplets N to the substrate W.

The gas for use is not limited to the nitrogen gas, and may be a compressed air, an argon gas, a carbon dioxide gas, and the like. The material of the nozzle(s) may be a resin, such as Teflon (Registered Trademark), instead of a metal.

Moreover, various inventions can be made by combining some of the multiple components disclosed in the embodiments of the present invention as appropriate. For instance, some components may be excluded from all the components shown in the embodiments of the present invention. Furthermore, components in one embodiment and components in the other embodiments may be combined together depending on the necessity.

What is claimed is:

1. A substrate processing apparatus configured to perform a cleaning process on a substrate by supplying liquid droplets to the substrate, the substrate processing apparatus comprising:
at least one liquid droplets supplying nozzle configured to eject liquid droplets; and
a liquid droplet atomizer configured to atomize the liquid droplets ejected from the liquid droplets supplying nozzle to supply the atomized liquid droplets to the substrate.

2. The substrate processing apparatus according to claim 1, wherein
the at least one liquid droplets supplying nozzle includes a plurality of nozzles and
the liquid droplet atomizer arranges the plurality of nozzles in a way that flows of the liquid droplets ejected respectively from the plurality of nozzles intersect with one another, and the liquid droplet atomizer thus forms a liquid-droplets intersecting area in which the liquid droplets ejected from the plurality of nozzles collide against one another.

3. The substrate processing apparatus according to claim 1, wherein the liquid droplet atomizer includes at least one gas supplying nozzle configured to supply a gas to the liquid droplets which are ejected from the liquid droplets supplying nozzle.

4. The substrate processing apparatus according to claim 3, wherein a nozzle axis of the gas supplying nozzle intersects a nozzle axis of the liquid droplets supplying nozzle in order to cause a turbulent flow of the liquid droplets in an area between an ejection port of the liquid droplets supplying nozzle and the substrate.

5. The substrate processing apparatus according to claim 2, the liquid droplet atomizer is a holding member configured to hold the plurality of nozzles integrally.

6. The substrate processing apparatus according to claim 3, the liquid droplet atomizer includes a holding member configured to hold the liquid droplets supplying nozzle and the gas supplying nozzle integrally.

7. The substrate processing apparatus according to claim 4, the liquid droplet atomizer includes a holding member configured to hold the liquid droplets supplying nozzle and the gas supplying nozzle integrally.

8. A substrate processing method for performing a cleaning process on a substrate by supplying liquid droplets to the substrate, the method comprising the steps of:
ejecting liquid droplets;
atomizing the liquid droplets more finely; and
supplying the atomized liquid droplets to the substrate.
